(19) United States
(12) Patent Application Publication
(10) Pub. No.: US 2004/0214594 A1
(43) Pub. Date: Oct. 28, 2004

(54) Device having smart user alert

(75) Inventor: Martin Earl Holman IV, Boca Raton, FL (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC., SCHAUMBURG, IL

(21) Appl. No.: 10/425,049

(22) Filed: Apr. 28, 2003

(51) Int. Cl. H04M 1/00

(52) U.S. Cl. 455/550.1; 455/575.7

(57) ABSTRACT

A device (104) such as a wireless phone, pager, organizer, PDA, or handheld PC includes an orientation sensor (300) to determine the orientation of the device (104). One of a first notification and a second notification is given to the user (102) of the device (104) based upon the determined orientation. An exemplary embodiment provides a first notification via an audible ringer (210) when the orientation of the device (104) is determined to be substantially horizontal. A second notification that is substantially inaudible is otherwise provided via a vibration generator (208).

### FIELD OF THE INVENTION

The present invention generally relates to the field of electronic devices, and more particularly relates to providing a notification from a device to a user.

### BACKGROUND OF THE INVENTION

Wireless receivers and transceivers, such as pagers and cellular telephones, have mechanisms to notify their users of various events, such as the receipt of an incoming message or call. Similarly, other handheld devices such as organizers and PDAs have mechanisms to notify their users of events such as calendar and task reminders. These types of devices are frequently carried by the user during the day and are brought into meetings and other situations where an audible notification, such as a ringing sound, is not desired. In order to better operate in situations where an audible notification is undesirable, many of these devices also have a vibrate mode in which the device provides a notification by silently vibrating. Using the vibrate mode provides the user with a physical (or touch-based) notification, as opposed to an audible notification, that an incoming message is being received. When the user no longer wishes to carry the device, he removes the device from his person and places it on a surface, such as a table. The user is then required to reconfigure the device to provide an audible notification. If the user forgets to reconfigure the device to provide an audible notification, he is unlikely to realize when an incoming message is received since the vibration of the device is unlikely to be noticed while the device off of the user's person (e.g., is sitting on the table).

Therefore a need exists to overcome the problems with the prior art as discussed above.

### SUMMARY OF THE INVENTION

According to a preferred embodiment of the present invention, a device has an orientation sensor that determines an orientation of the device. The device also has a notification generator, which is communicatively coupled to the orientation sensor, and that provides one of a first notification and a second notification from the device. The form of the notification produced by the notification generator is based upon the orientation.

According to a preferred embodiment of the present invention, a method consists of determining an orientation of a device. The method then provides one of a first notification and a second notification from the device. The form of the notification that is provided is based upon the orientation.

### BRIEF DESCRIPTION OF THE DRAWINGS

FIG. 1 is an operational environment for a handheld device according to an exemplary embodiment of the present invention.

FIG. 2 is a block diagram of a handheld device according to an exemplary embodiment of the present invention.

FIG. 3 is a cut away view of a gravity sensitive orientation sensor used in an exemplary embodiment of the present invention.

FIG. 4 is a cut away view of a wireless phone incorporating the gravity sensitive orientation sensor of FIG. 3.

FIG. 5 is a processing flow diagram for a smart alert mode of a handheld device according to a preferred embodiment of the present invention.

FIG. 6 is a sensor clip attached to a wireless phone according to one embodiment of the present invention.

### DETAILED DESCRIPTION

The present invention, according to a preferred embodiment, overcomes problems with the prior art by providing a handheld device such as a wireless transceiver (e.g., cellular phone or smart phone), pager, organizer, PDA, handheld PC, or the like. This handheld device is able to be configured into a “smart alert” mode that provides an audible notification of events, such as incoming calls, when the device has a substantially horizontal orientation. The smart alert mode provides a vibrate-only notification if the device is not substantially horizontal. Preferably, the device is also able to be configured into the conventional audible and non-audible notification modes. Further embodiments of the “smart alert” mode of the present invention are similarly used with other computing and communications devices that provide any notifications to their users. Some embodiments change notification modes based upon other orientations of the device, such as vertical or other orientations.

The present invention will now be described in more detail with reference to exemplary embodiments in which a smart alert mode is incorporated into a handheld radio communications transceiver. However, the present invention is not limited to such a device, but is more generally applicable to any device that provides a notification to a user.

An operational environment 100 for an exemplary embodiment of the present invention is illustrated in FIG. 1. The operational environment 100 shows a user 102 with a cellular phone 104 or other handheld device attached to his person, (e.g., onto a belt or other article of clothing). The phone 104 in this example is configured to operate in the smart alert mode. While the phone 104 is attached to the user, the phone is in a substantially vertical orientation. While in this substantially vertical orientation, the smart alert feature provides substantially non-audible notification of incoming calls and messages by vibrating. When the user 102 no longer wishes to carry the phone 104, the user 102 puts the phone 104 onto a surface such as table 106. When placed on the table 106, the phone 104 is in a substantially horizontal orientation. If the phone 104 were in a non-audible vibrate mode while on the table 106, the user 102 would be unlikely to notice the vibration and miss incoming calls. The smart alert mode of the exemplary embodiment of the present invention determines the substantially horizontal orientation of the phone 104 and cause the phone 104 to provide an audible notification of an incoming call or message when the phone 104 is in such a substantially horizontal orientation, and provides a vibrate only notification otherwise.

A block diagram 200 of a cellular phone 104 according to an exemplary embodiment of the present invention is illustrated in FIG. 2. The cellular phone 104 has a controller 202 that performs the software processing to operate the phone 104 in the exemplary embodiment of the present invention. The controller 202 controls and receives information from the communications circuits 204. Cellular phone 104 also has memory circuits 216 that are used to store permanent and volatile data to support processing by controller 202.

Communications circuits 204 perform the voice and data communications over a wireless link to a remote station. Communications circuits 204 receive calls and incoming messages and provide an indication of these incoming calls and messages to controller 202. The controller 202 then performs the processing, described below, to implement the smart alert mode.

Cellular phone 104 also has a keypad 214 and a display 212. The keypad 214 performs the keypad functions of conventional cellular phones. The keypad 214 further allows the cellular phone 104 of the exemplary embodiment to be placed into a smart alert mode. The display 212 is similar to the display of a conventional cell phone and performs similar functions. The display 212 of the exemplary embodiment further provides the user 102 with an indication of the notification mode in which the phone 104 is currently configured.

Phone 104 has an orientation sensor 206 that determines the orientation of the phone 104. The orientation sensor of the exemplary embodiment determines if the phone 104 is in a substantially horizontal orientation. Alternative embodiments incorporate orientation sensors that determine if a device is within a specified range of orientation, such as substantially vertical or another specified range of orientation. Preferred embodiments of the present invention utilize orientation sensors that include gravity sensitive mechanisms to determine orientation or a clip sensor to determine if a user has attached the phone 104 or other handheld device to his or her person.

The phone 104 also has two notification generators, an audible ringer 210 and a vibration generator 208. The audible ringer 210 provides an audible notification of certain events to the user, such as incoming phone calls or messages. The vibration generator 208 is used as an alternative to, or in conjunction with, the audible ringer 210 to vibrate the phone 104 in order to notify the user of events. The smart alert mode of the exemplary embodiment provides a notification in one of two forms by using one of the audible ringer 210 or the vibration generator 208 to provide different forms of notification to the user based upon the orientation of the phone 104. The exemplary embodiment is also able to enable and disable the audible notification based upon the orientation of the phone 104, so that the phone 104 is configured to provide either a vibration only notification or a combination of an audible and an additional notification that includes a vibrating notification, based upon the orientation and configuration of the phone 104.

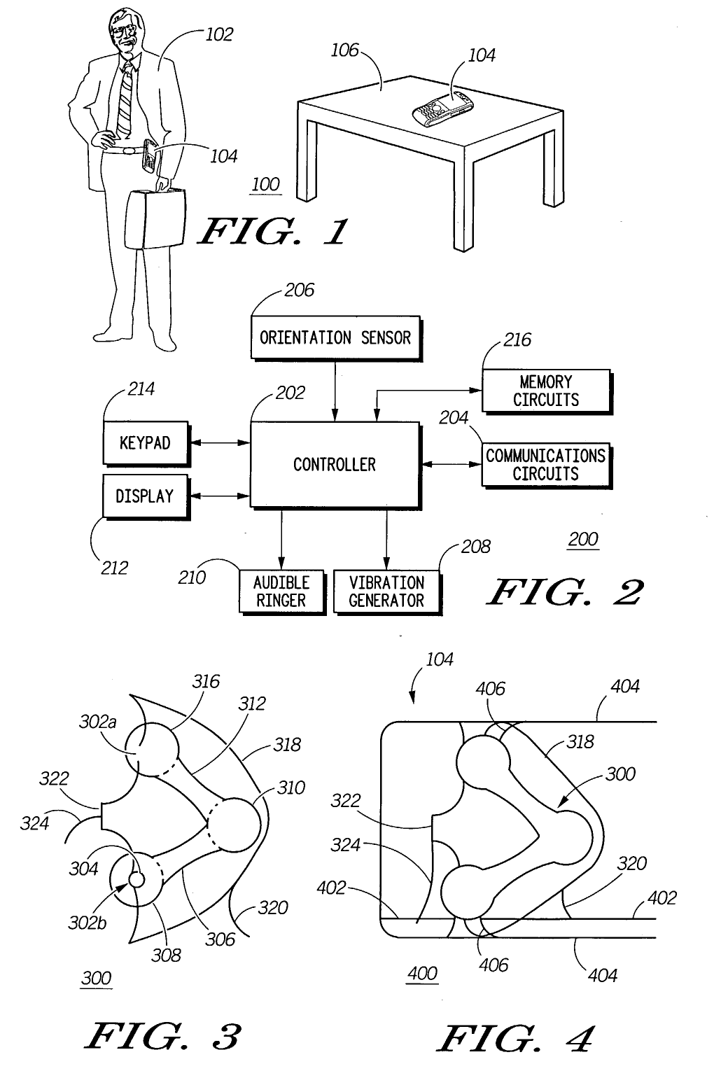

A gravity sensitive orientation sensor 300 incorporated into an exemplary embodiment of the present invention is illustrated in FIG. 3. The gravity sensitive orientation sensor 300 has a first chamber 310 and a second chamber 308. The first chamber 310 and second chamber 308 of the exemplary embodiment are essentially spherical chambers that open to a channel 306. Channel 306 is a hollow duct that connects the interior of the first chamber 310 to the interior of the second chamber 308. First chamber 310 also opens to an auxiliary channel 312. The auxiliary channel 312 in the exemplary embodiment is similar to channel 306 and connects the interior of the first chamber to the interior of an auxiliary chamber 316.

The three chambers of the exemplary gravity sensitive orientation sensor 300 (the first chamber 310, the second chamber 308, and the auxiliary chamber 316), in conjunction with the two channels (the channel 306 and the auxiliary channel 312), define an enclosed pathway. A conductive ball 304 is placed within this enclosed pathway. The size of the conductive ball 304 relative to the openings' of the enclosed pathway is such that the conductive ball is able to move freely along the auxiliary channel 312 and the channel 306 and rest in any of the three chambers.

The second chamber 308 and the auxiliary chamber 316 each have a pair of contacts, primary contacts 302b and auxiliary contacts 302a, that are positioned so as to allow the conductive ball 304 to rest between the pair of contacts when the gravity sensitive orientation sensor 300 has a desired orientation. In the exemplary embodiment, the desired orientation corresponds to a substantially horizontal orientation of the phone 104 when the phone 104 is resting on its front or back surface. First conductor 322 connects one of the contacts of each of the pair of contacts. A second conductor 318 connects the other contact of each of the pair of contacts. This allows a circuit to be completed between the first conductor 322 and the second conductor 318 when the conductive ball 304 is placed across the pair of contacts. First conductor 322 has an attached first connection 324 to allow the first conductor to be electrically connected to a circuit board in the phone 104. The second conductor 318 similarly has an attached second connection 320 to allow electrical connection of the second conductor 318 to the circuit board. This embodiment of a gravity sensitive orientation sensor 300 therefore completes an electrical circuit connection between the first connection 324 and the second connection 320 when the sensor 300 is in a desired orientation and leaves that electrical circuit connection open when the sensor 300 is not oriented in the desired orientation. More specifically, when the sensor (i.e., phone) is not in a substantially horizontal orientation, the conductive ball 304 rests in the first chamber 310, so as to not complete the electrical circuit connection described above.

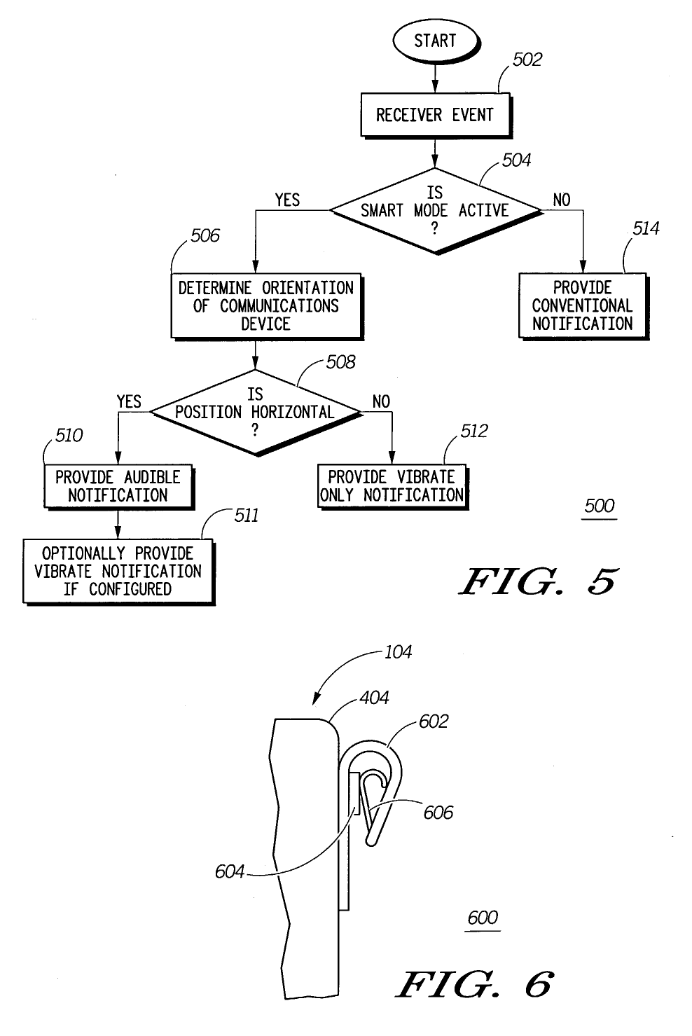

An internal phone cross-section 400 according to an exemplary embodiment of the present invention is illustrated in FIG. 4. The internal phone cross-section 400 is a cut-away side view of phone (or other handheld device) 104. The phone 104 is shown in a horizontal orientation. The gravity sensitive orientation sensor 300 is mounted to the phone shell 404 by mounting brackets 406. A circuit board 402 is mounted within the phone shell 400 and contains electrical circuits used by the phone 104. The first conductor 322 of the gravity sensitive orientation sensor 300 is electrically connected to a point on the circuit board 402 by the first connector 324. The second conductor 318 of the gravity sensitive orientation sensor 300 is electrically connected to another point on the circuit board 402 by the second connector 320. The circuitry on circuit board 402 senses whether the electrical connection is completed or opened in the gravity sensitive orientation sensor 300 to determine the orientation of the phone 104, and configures the circuitry to use the proper notification generator to provide the desired notification based upon the orientation of the phone 104, as is described in more detail below.

A top-level processing flow diagram 500 of a smart alert mode operation according to an exemplary embodiment of the present invention is illustrated in FIG. 5. The top-level processing begins by receiving, at step 502, an event, such as an incoming call or message, that is to trigger a notification to the user 102 of the phone 104. Once this event is received, the processing advances to determining, at step 504, if smart mode is active. If smart mode is active, the processing continues by determining, at step 506, the orientation of the phone 104. The exemplary embodiment described above determines the orientation of the phone 104 by monitoring the electrical contact closure within the gravity sensitive orientation sensor 300. However, in further embodiments, the orientation of the phone (or any other handheld device) can be determined by any type of sensor or other means that can determine the general orientation of the device. If the phone 104 is determined, at step 508, to be substantially horizontal, the processing proceeds to providing, at step 510, an audible notification of the incoming call. If the phone 104 is determined, at step 508, to not be substantially horizontal, the processing advances to providing, at step 512, a substantially non-audible vibrate only notification of the incoming call. In some embodiments, if the phone is determined, at step 508, to be substantially horizontal, a vibrate notification is also provided, at optional step 511.

If it was determined, at step 504, that smart mode was not active, a conventional notification is provided, at step 514.

Embodiments of the present invention utilize various types of orientation sensors. Embodiments of the present invention utilize orientation sensors that use mercury or other conducting liquids that are contained within a cavity and that have electrical contacts placed within that cavity so that an electrical connection is completed or opened as the conducting liquid moves within the cavity due to different orientations of the cavity. Other embodiments utilize orientation sensors that include spirit levels or other gravity sensitive mechanisms that can be monitored to determine the orientation of the device.

Further embodiments of the present invention utilize a clip sensor as an orientation sensor. Such clip sensors are used in conjunction with a physical clip on the device that is used to attach the device to the user of the device, such as by attaching the device to a belt or to another article of the user's clothing. These clip sensors provide an electronically readable indication of whether the clip is engaged on a belt or otherwise attached to the user, or if the clip is not engaged on anything and therefore not attached to the user. It is to be understood that a determination of “orientation,” as is used within this disclosure, includes a determination of whether such a clip is attached to a user. If the clip indicates that the device is attached to a user, the determination is made that the device is not substantially horizontal. Although it is possible for the device to be substantially horizontal while attached to a user, these embodiments assume this is not the case when the device is attached to a user.

An example of a phone with a clip sensor 600 according to embodiments of the present invention is illustrated in FIG. 6. The phone with a clip sensor 600 includes a wireless phone 104 with a phone shell 404 onto which is attached a clip 602. Clip 602 has a fixed contact 604 and a flexible contact 606 that are arranged such that the flexible contact 606 is in contact with the fixed contact 604 when the clip is not attached to an object. The circuitry of the wireless phone 104 monitors whether the circuit across the fixed contact 604 and the flexible contact 606 is open or completed. If the circuit is open, the processing of these embodiments accept this as an indication that the clip 602, and therefore the wireless phone 104, is attached to a person and therefore an audible notification is not to be provided if the smart alert mode is active. If the circuit across the fixed contact 604 and the flexible contact 606 is completed, the processing accepts this as an indication that the clip 602, and therefore the wireless phone 104, is not attached to a person and an audible notification is to be provided if the smart alert mode is active.

Exemplary embodiments of the present invention advantageously provide for an automatic reconfiguration of notification modes to allow a phone or other handheld device to provide a notification to the user that the user is most likely to notice under present operating conditions. A phone in a substantially horizontal orientation is unlikely to be attached to the user and therefore a silent vibration is unlikely to be noticed. A phone that is not substantially horizontal is likely to be attached to the user and therefore the user is likely to notice a vibration notification. This change in notification mode is performed without input from the user and therefore obviates missing notifications because the phone or other device was not reconfigured to provide an audible notification when removed from the user.

The present invention can be realized in hardware, software, or a combination of hardware and software. A system according to a preferred embodiment of the present invention can be realized in a centralized fashion in one information processing system, or in a distributed fashion where different elements are spread across several interconnected information processing systems. Any kind of information processing system—or other apparatus adapted for carrying out the methods described herein—is suited. A typical combination of hardware and software could be a general purpose processor with a machine readable program that, when being loaded and executed, controls the device such that it carries out the methods described herein.

The present invention can also be embedded in a computer program product, which comprises all the features enabling the implementation of the methods described herein, and which—when loaded in an information processing system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each information processing system may include, inter alia, one or more processors and at least a computer or machine readable medium allowing data, instructions, messages or message packets, and other machine readable information to be read from the computer readable medium. The computer or machine readable medium may include non-volatile memory, such as ROM, Flash memory, Disk drive memory, CD-ROM, and other permanent storage. Additionally, a computer or machine readable medium may include, for example, volatile storage such as RAM, buffers, cache memory, and network circuits. Furthermore, the computer or machine readable medium may comprise computer or machine readable information in a transitory state medium such as a network link and/or a network interface, including a wired network or a wireless network, that allow a device to read such computer or machine readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method comprising:
determining an orientation of a device; and
providing one of a first notification and a second notification from the device based upon the orientation.

2. The method according to claim 1, wherein the second notification comprises the first notification and an additional notification.

3. The method according to claim 1, wherein the determining step includes the sub-step of determining an open or closed status of a clip on the device.

4. The method according to claim 1, wherein the determining step includes the sub-step of monitoring an orientation sensor.

5. The method according to claim 4, wherein the monitoring of an orientation sensor comprises:
monitoring whether an electrical connection completed or opened in a gravity sensitive orientation sensor, wherein the step of monitoring whether an electrical connection completed or opened comprises:
providing a conducting object;
providing a first chamber and a second chamber, wherein the first and second chambers are able to accept the conducting object;
providing a channel, connecting the first chamber and the second chamber and able to allow the conducting object to travel between the first chamber and the second chamber; and
providing a pair of contacts positioned within the second chamber, wherein the conducting object engages the pair of contacts and forms a conducting circuit across the pair of contacts when the second chamber has a desired orientation.

6. The method according to claim 5, wherein the step of monitoring whether an electrical connection completed or opened further comprises:
providing an auxiliary chamber;
providing an auxiliary channel, wherein the auxiliary channel connects the auxiliary chamber to the first chamber; and
providing an auxiliary pair of contacts positioned within the auxiliary chamber, wherein the conducting object engages the auxiliary pair of contacts and forms a conducting circuit across the auxiliary pair of contacts when the auxiliary chamber has a desired orientation.

7. The method according to claim 5, wherein the step of monitoring whether an electrical connection completed or opened further comprises:
providing an auxiliary chamber; and
providing an auxiliary channel, wherein the auxiliary channel connects the auxiliary chamber to the second chamber.

8. The method according to claim 1, wherein the first notification is an audible notification and is provided when the orientation is determined to be within a specified range, and the second notification is a substantially inaudible notification and is provided otherwise.

9. The method according to claim 8, wherein the specified range corresponds to a substantially horizontal orientation of the device.

10. The method according to claim 8, wherein the substantially inaudible notification comprises vibrating the device.

11. A device comprising:
an orientation sensor for determining an orientation of the device; and
a notification generator, communicatively coupled to the orientation sensor, for providing one of a first notification and a second notification from the device based upon the orientation.

12. The device according to claim 11, wherein the second notification comprises the first notification and an additional notification.

13. The device according to claim 11, wherein the orientation sensor comprises a status sensor for determining an open or a closed status of a clip on the device.

14. The device according to claim 11, wherein the orientation sensor comprises:
a conducting object;
a first chamber and a second chamber, wherein the first and second chambers are able to accept the conducting object;
a channel, connecting the first chamber and the second chamber and able to allow the conducting object to travel between the first chamber and the second chamber; and
a pair of contacts positioned within the second chamber, wherein the conducting object engages the pair of contacts and forms a conducting circuit across the pair of contacts when the second chamber has a desired orientation.

15. The device according to claim 14, further comprising:
an auxiliary chamber;
an auxiliary pair of contacts positioned within the auxiliary chamber, wherein the conducting object engages the auxiliary pair of contacts and forms a conducting circuit across the auxiliary pair of contacts when the auxiliary chamber has a desired orientation; and
an auxiliary channel, wherein the auxiliary channel connects the auxiliary chamber to the first chamber.

16. The device according to claim 14, further comprising:
an auxiliary chamber; and
an auxiliary channel, wherein the auxiliary channel connects the auxiliary chamber to the second chamber.

17. The device according to claim 11, wherein the first notification is an audible notification and is provided when the orientation is determined to be within a specified range, and the second notification is a substantially inaudible notification and is provided otherwise.

18. The device according to claim 17, wherein the specified range corresponds to a substantially horizontal orientation of the device.

19. The device according to claim 17, wherein the notification generator comprises a vibration generator and the second notification comprises vibrating the device.

20. A computer program product comprising computer programming instructions for:
determining an orientation of a device; and
providing one of a first notification and a second notification from the device based upon the orientation.
